(19) United States
(12) Patent Application Publication
(10) Pub. No.: US 2026/0009475 A1
(43) Pub. Date: Jan. 8, 2026

(54) Valve Assembly Housing

(71) Applicant: Eaton Intelligent Power Limited, Dublin 4 (IE)

(72) Inventors: Raymond McLauchlan, Macomb Township, MI (US); Rythm Jain, Delhi (IN); Brian James O’Neil, Chesterfield Twp, MI (US); Mark William Hildebrandt, Hartland, MI (US)

(21) Appl. No.: 19/323,629

(22) Filed: Sep. 9, 2025

Related U.S. Application Data
(63) Continuation of application No. PCT/IB2024/052906, filed on Mar. 26, 2024.

(30) Foreign Application Priority Data
Mar. 27, 2023 (IN) 202311021888

(51) Int. Cl. F16K 27/02; F16K 1/42

(52) U.S. Cl. CPC F16K 27/029; F16K 1/42

(57) ABSTRACT

In one embodiment, a valve assembly housing configured to house a valve assembly for a fuel tank is provided. The valve assembly housing includes an inlet, an outlet positioned parallel to and lower than the inlet, a valve cavity connected between the inlet and the outlet, and a main seat positioned in the valve cavity at a location proximate to where the valve cavity transitions to the outlet. The outlet and the inlet have different axes. The valve cavity is configured to house the valve assembly. The main seat is configured to support a spring of the valve assembly disposed along a center axis of the valve cavity. The main seat includes a retainer configured to retain the spring on the main seat.

### CROSS-REFERENCE TO RELATED APPLICATIONS

This application claims the benefit under 35 U.S.C. § 365(c) of International Patent Application No. PCT/IB2024/052906, filed 26 Mar. 2024, which claims the benefit under 35 U.S.C. § 119(a) of Indian Provisional Patent Application No. 202311021888, filed 27 Mar. 2023, which is incorporated herein by reference

### TECHNICAL FIELD

This disclosure generally relates to a valve system, and more particularly to a valve assembly housing.

### BACKGROUND

High-pressure fuel tanks have been useful especially in electric hybrid and gasoline-powered vehicles. In order to comply with environmental and safety regulations imposed on these vehicles, isolation valves are typically employed to control and recover fuel vapor emission from the fuel tank. Such isolation valve may be positioned within a valve housing structure and configured to open and close a vapor path from the fuel tank so as to isolate fuel vapor emissions and prevent overloading of the fueling system. The traditional types of valve housing structures associated with the isolation valve rely on complex mechanical features for positioning the isolation valve on the proper location and are therefore bulky and costly to manufacture. Moreover, due to the high complexity of the housing structure, flow rate and flow capability of the vapor path passing through the housing may be compromised, thus derating fuel tank recovery and depressurization performance. Improvements are accordingly desired.

### SUMMARY OF PARTICULAR EMBODIMENTS

This disclosure presents a valve assembly housing configured for housing a valve assembly. The valve assembly housing may be configured to house various components of the valve assembly and properly align and retain these valve components without sacrificing flow capability. Moreover, the valve assembly housing may be designed with simple structures that allow easy manufacturing at a low cost.

In one embodiment, a valve assembly housing configured to house a valve assembly for a fuel tank is provided. The valve assembly housing includes an inlet, an outlet positioned parallel to and lower than the inlet, a valve cavity connected between the inlet and the outlet, and a main seat positioned in the valve cavity at a location proximate to where the valve cavity transitions to the outlet. The outlet and the inlet have different axes. The valve cavity is configured to house the valve assembly. The main seat is configured to support a spring of the valve assembly disposed along a center axis of the valve cavity. The main seat includes a retainer configured to retain the spring on the main seat.

In particular embodiments, the valve assembly housing further includes one or more side seats, which are configured to support the spring of the valve assembly together with the main seat. In particular embodiments, the main seat and one or more side seats together form a supporting plane for supporting the spring thereon. In particular embodiments, the one or more side seats are positioned on a side wall of the valve cavity. In particular embodiments, fluid channels are formed between the main seat and the one or more side seats. In particular embodiments, the fluid channels extend towards the outlet.

In particular embodiments, the main seat is positioned at a bottom of the valve cavity. In particular embodiments, the retainer prevents the spring from deflecting away from the center axis. In particular embodiments, the retainer is configured proximately to an outer periphery of the spring. In particular embodiments, the retainer is a protrusion extending from the main seat. In particular embodiments, the main seat is formed integrally with the valve cavity. In particular embodiments, the main seat is formed by injection molding or insert molding. In particular embodiments, the retainer is formed by injection molding or insert molding. In particular embodiments, the main seat is configured with a shape of an airfoil. In particular embodiments, the main seat has a length that spans across a diameter of the spring.

In one embodiment, a valve system includes a valve assembly having a spring, and a valve assembly housing. The valve assembly housing includes an inlet, an outlet positioned parallel to and lower than the inlet, a valve cavity connected between the inlet and the outlet, and a main seat positioned in the valve cavity at a location proximate to where the valve cavity transitions to the outlet. The outlet and the inlet have different axes. The valve cavity is configured to house the valve assembly. The main seat is configured to support a spring of the valve assembly disposed along a center axis of the valve cavity. The main seat includes a retainer configured to retain the spring on the main seat.

In particular embodiments, the valve assembly housing further includes one or more side seats, which are configured to support the spring of the valve assembly together with the main seat. In particular embodiments, the main seat and the one or more side seats together form a supporting plane for supporting the spring thereon.

In one embodiment, a valve system includes a valve assembly having a spring, and a valve assembly housing. The valve assembly housing includes an outlet, a valve cavity connected to the outlet, and a main seat positioned in the valve cavity at a location proximate to where the valve cavity transitions to the outlet. The valve cavity is configured to house the valve assembly. The main seat is configured to support the spring of the valve assembly disposed along a center axis of the valve cavity. The main seat includes a retainer configured to retain the spring on the main seat.

In particular embodiments, the valve assembly housing further includes one or more side seats, which are configured to support the spring of the valve assembly together with the main seat.

### BRIEF DESCRIPTION OF THE DRAWINGS

Embodiments in accordance with this disclosure will now be described by reference to the accompanying drawings.

FIG. 1 illustrates a perspective view of an embodiment of a valve system, with a valve assembly housing of the valve system shown in cross section.

FIG. 2 illustrates a cross-sectional view of an embodiment of a valve assembly housing.

FIG. 3 illustrates a perspective view of an embodiment of a spring seat assembly.

FIGS. 4-5 illustrate an embodiment of a spring seat assembly from different cross sections.

### DESCRIPTION OF EXAMPLE EMBODIMENTS

This disclosure in general presents a valve assembly housing that is suitable for housing a valve assembly typically used in a fuel tank. In particular, the housing according to this disclosure utilizes a spring seat assembly to support a spring of the valve assembly and keep the spring proper alignment with valve components. For example, in one embodiment, the spring seat assembly may include one or more seats configured for supporting the spring thereon. The seats may be spaced apart from one another in a way to form relatively large openings therebetween such that, during operation of the valve assembly, these openings may serve as flow channels for fluid to pass through. In other words, the structures of the spring seat assembly may not only provide stable support to the spring but at the same time enable large throughflow area and optimal flow capacity, for example, for fuel vapor passage. The design of the valve assembly housing disclosed herein contrasts those of prior art since the valve assembly housing can sufficiently support and secure the spring while providing improved pressure drop and flow characteristics for the fluid passing therethrough. This is extremely critical and competitive in the field of fuel vapor management where high flow rate and rapid pressure communication are widely desired. Moreover, the valve assembly housing disclosed herein requires less complicated structures and therefore can be manufactured in a much easier and cheaper way. The benefits provided by the valve assembly housing of this disclosure are monumental given its broad application in many industries, especially the motor vehicle industry that is highly sensitive to production cost.

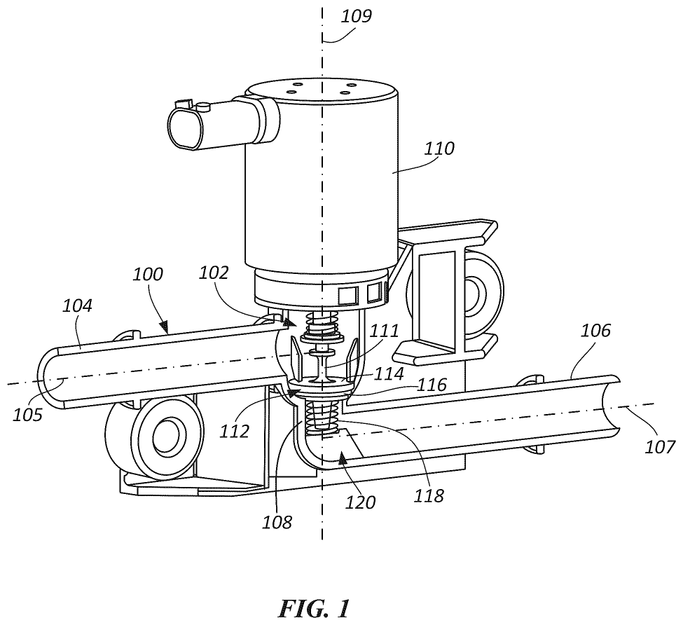

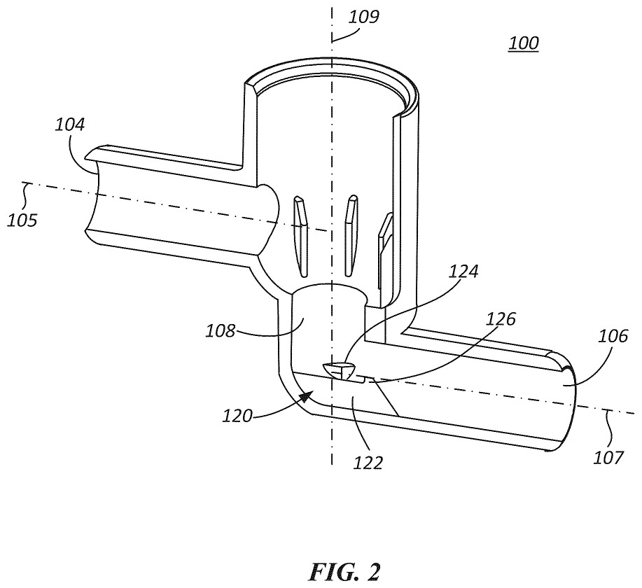

FIG. 1 illustrates an embodiment of a valve system, which incorporates a valve assembly housing 100 and a valve assembly 102 housed by the valve assembly housing 100. FIG. 2 illustrates an embodiment of the valve assembly housing 100 shown in cross section, with components of the valve assembly 102 omitted.

In particular embodiments, the valve assembly housing 100 may include an inlet 104 and an outlet 106. As an example and not by way of limitation, when used in connection with a fuel tank system, the inlet 104 may be fluidly coupled to a fuel tank, which may be configured for holding fuel to be supplied, for example, to an internal combustion engine of a vehicle. The outlet 106 may be fluidly coupled to a vapor recovery canister, which may be adapted to collect fuel vapor emitted by the fuel tank and to subsequently release the fuel vapor to the engine. Alternatively, in certain embodiments, the valve assembly housing 100 may be configured elsewhere, such as between a vapor recovery canister and an engine or other suitable locations in the fuel tank system. In particular embodiments, the inlet 104 and the outlet 106 may be arranged on the valve assembly housing 100 in a substantially parallel relationship. In the embodiment as depicted, the inlet 104 and the outlet 106 are configured on opposing sides of the valve assembly housing 100, with the outlet 106 being lower than the inlet 104. As an example and not by way of limitation, an inlet axis 105 of the inlet 104 and an outlet axis 107 of the outlet 106 may be configured in parallel and at a distance with respect to each other. As used herein, “parallel” may be used to denote an angle between 175 degrees and 185 degrees, and preferably 180 degrees.

In particular embodiments, the valve assembly housing 100 may include a valve cavity 108 connected between the inlet 104 and the outlet 106. For example, the valve cavity 108 may be fluidly coupled to the inlet 104 and the outlet 106 in a way to enable fluid communication between the inlet 104 and the outlet 106. In particular embodiments, the valve cavity 108 may extend downwards from one end of the inlet 104 to one end of the outlet 106. As an example and not by way of limitation, the valve cavity 108 may be configured with a vertical center axis 109, which is orientated substantially perpendicular to the inlet axis 105 and the outlet axis 107. Accordingly, the valve assembly housing 100 provides a compact and streamlined structure. Moreover, the valve assembly housing 100 may be readily attached to existing components of a typical fuel tank system in the market without requiring substantial modification to the surrounding architecture, thereby significantly simplifying the mounting process.

In particular embodiments, the valve cavity 108 may be configured to receive the valve assembly 102. As an example and not by way of limitation, the valve assembly 102 may be a single stage valve assembly suitable for high efficiency vapor management or other suitable types of valves such as a multi-stage valve. In particular embodiments, the valve assembly 102 may incorporate an over pressure relief (OPR) functionality and an over vacuum release (OVR) functionality, which, for example, may be configured in an in-line relationship. During operation with the fuel tank system, the valve assembly 102 may control fuel vapor flow between a fuel tank and a vapor recovery canister. As an example and not by way of limitation, the valve assembly 102 may be controlled to selectively open and/or close a valve in order to perform OPR and/or OVR operation for the fuel tank as needed. In particular embodiments, the valve assembly 102 may be configured to control a flow of fuel vapor between the inlet 104 and the outlet 106 so as to perform fuel recovery procedure between the fuel tank and the fuel recovery canister. This may be useful in the context of pressurized fueling, such as for a hybrid vehicle fuel system. For example, when the vehicle is operating in an electric mode, the fuel tank becomes a closed (unvented) system. Fuel can be volatile from extreme temperatures and/or sloshing within the fuel tank, creating undesirable elevated pressure within the fuel tank. When the pressure exceeds a predetermined threshold, the valve assembly 102 may pulse (i.e., a series of opening and closing events) to relieve the pressure within the fuel tank.

In particular embodiments, the valve assembly 102 may include a solenoid assembly 110. For example, the solenoid assembly 110 may be adapted to receive electrical power and energized by a control signal. Specifically, in the illustrated embodiment, the solenoid assembly 110 may include a poppet 111, which may be configured to move along the center axis 109 of the valve cavity 108. During operation, when being triggered by a control signal, the solenoid assembly 110 may be energized and cause the poppet 111 to translate upwardly in a way to allow fluid to pass through the valve cavity 108. The solenoid assembly 110 described herein is merely exemplary, other suitable mechanism for actuating the valve assembly 102 (such as a mechanical actuator, a hydraulic actuator, etc.) are also contemplated by this disclosure.

In particular embodiments, the valve assembly 102 may include an over pressure relief (OPR) valve 112. The OPR valve 112 may be positioned on the center axis 109 of the valve cavity 108 and configured to be in line with the poppet 111 of the solenoid assembly 110. In particular embodiments, the OPR valve 112 may include a piston 114 and a compliant seal 116. As an example and not by way of limitation, the piston 114 and the compliant seal 116 may be formed as a unitary piston assembly via appropriate manufacturing process (such as over-molding) or separately provided and assembled together as needed. In particular embodiments, the valve assembly 102 may further include a spring 118, which may be configured to urge the piston 114 and the compliant seal 116 in the axial direction. As an example and not by way of limitation, the spring 118 may be rated to compress upon a threshold pressure being reached in the fuel tank, allowing the piston 114 and the compliant seal 116 to translate along the center axis 109 and mechanically open a passage to relieve pressure in the fuel tank. In particular embodiments, the spring 118 may be a straight spring, a conical spring, or other suitable types of spring. In particular embodiments, the valve assembly 102 may incorporate other suitable components as desired, details of which are not described herein so as to avoid obscuring the scope of this disclosure. In addition, various features and aspects of the valve assembly 102 may be omitted without departing from the scope of this disclosure.

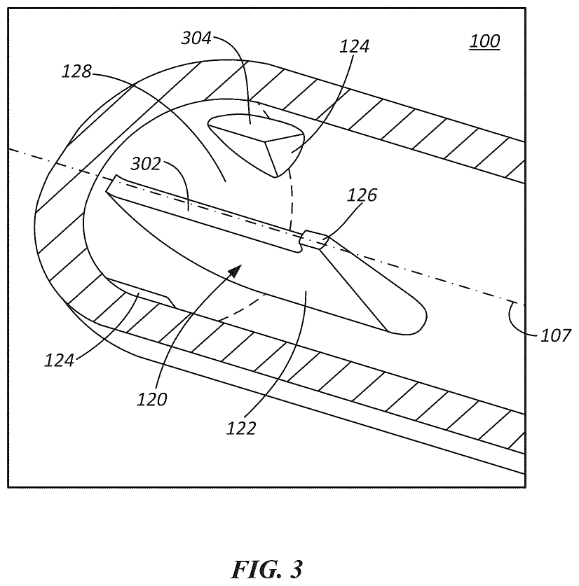

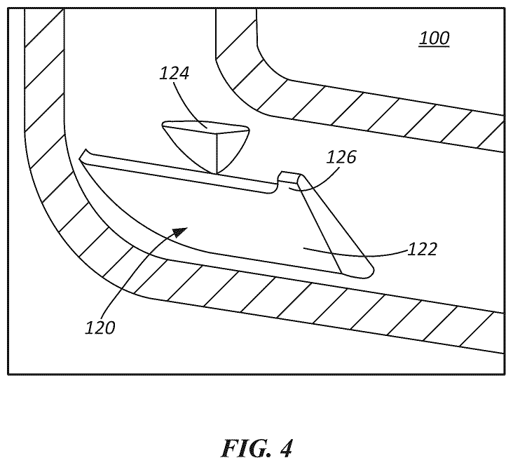

In particular embodiments, the valve assembly housing 100 may also include a spring seat assembly 120 configured to support the spring 118 of the valve assembly 102. As an example and not by way of limitation, the spring seat assembly 120 may be positioned in the valve cavity 108 (e.g., at a location proximate to where the valve cavity 108 transitions to the outlet 106) and configured to support and align the spring 118 along the center axis 109 of the valve cavity 108. Moreover, the spring seat assembly 120 may also be configured to retain the spring 118 and prevent the spring 118 from shifting away from the center axis 109. The spring seat assembly disclosed herein may advantageously offer numerous benefits including but not limited to ensuring proper positioning and alignment of components of the valve assembly, providing optimal fluid dynamics, simplifying manufacturing process of the housing structure, reducing assembly cost, and so forth, details of which will be described with reference to FIGS. 3-5.

FIGS. 3-5 illustrates partial cross-sectional views of the valve assembly housing 100, specifically delineating the spring seat assembly 120 from different perspectives. In particular embodiments, the spring seat assembly 120 may be located in the valve cavity 108 and configured for supporting the spring 118 on the center axis 109 (shown in FIG. 1). As an example and not by way of limitation, components of the spring seat assembly 120 may be formed integrally with the valve cavity structure, for example, by injection molding or other suitable manufacturing process. Alternatively, the spring seat assembly 120 may be separately provided and assembled to the valve cavity 108 such as via insert molding, ultrasonic welding, etc. In particular embodiments, the spring seat assembly 120 may include a main seat 122, which may be positioned at a location proximate to where the valve cavity 108 transitions to the outlet 106, such as at a bottom of the valve cavity 108. In particular embodiments, the spring seat assembly 120 may also include one or more side seats 124, which may be positioned on an inner wall of the valve cavity 108. As depicted in FIG. 3, for example, two side seats 124 are shown as being symmetrical with each other with respect to the outlet axis 107. Although depicted as having two side seats, the spring seat assembly include any suitable number of the side seat for holding the spring in place. In the embodiment of FIG. 3, a top surface 302 of the main seat 122 may stay flush with top surfaces 304 of the side seats 124 in a way to form a seating plane suitable for positioning and supporting the spring 118 on the center axis 109. In particular embodiments, the main seat 122 may have a length that spans across a diameter of the spring 118 so as to provide two supporting points along the diameter of the spring 118. The side seats 124 may provide further supporting points on the circumference of the spring 118. For example, when the valve assembly 102 of FIG. 1 is received in the valve cavity 108 and the spring 118 sits in place on the spring seat assembly 120, four vertical axes of the spring 118—e.g., with a 90-degree spacing from each other in the radial direction—may be supported by the main seat 122 and the two side seats 124, respectively. In doing so, the spring seat assembly 120 provides a wide and stable base for supporting the spring 118 on a desired position and orientation.

In particular embodiments, the main seat 122 and the side seats 124 may be configured to be spaced apart from each other so as to form fluid channels therebetween. As an example and not by way limitation, two channels 128 are formed between the main seat 122 and the side seats 124 and configured to extend along the outlet axis 107 of the outlet 106. This may facilitate fluid flow through the spring seat assembly 120 without substantially restricting fluid passage volume. Of course, other suitable numbers and orientation of the fluid channel may be used without departing from the scope of this disclosure. During operation, when the OPR valve 112 is in an open position (e.g., enabling fluid passage from the inlet 104 through the valve cavity 108 to the outlet 106), fluid entering the valve cavity 108 may flow through the OPR valve 112 in a downward direction into the channels 128 between the main seat 122 and side seats 124 and smoothly turn horizontally to a direction towards the outlet 106, for example, by following a round corner of the valve assembly housing 100. As such, the spring seat assembly 120 may allow the fluid to pass at a high rate without substantially reducing the volume for fluid flow. Such improved fluid communication enabled by the spring seat assembly according to this disclosure is especially beneficial in vehicle operations where optimal flow capability and rapid pressure and/or vacuum relief are highly sought.

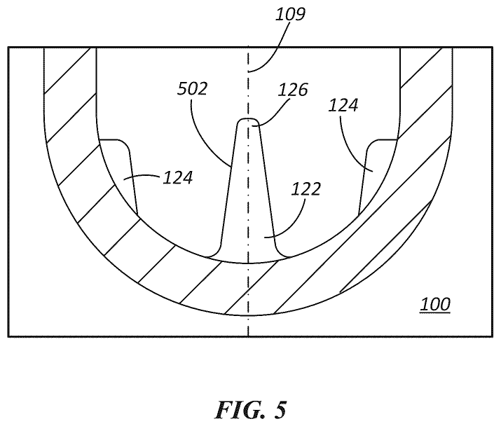

In particular embodiments, the main seat 122 may be configured with a shape that is similar to an airfoil design or other suitable shapes that are streamlined and flow friendly such as elongated, smooth-surfaced, etc. As an example and not by way of limitation, side surfaces 502 of the main seat 122 may be sloped towards the center axis 109 in a way to reduce eddy effect of the fluid flow (this can be observed in FIG. 5). Additionally or alternatively, the main seat 122 and the side seats 124 may be rounded so as to further improve flow characteristics. Although not shown, other suitable forms and configurations of the main seat 122 and side seats 124 are also contemplated by this disclosure for achieving the desired flow dynamics.

Additionally, in particular embodiments, the main seat 122 may include a retainer 126, which may be configured to retain the spring 118 on the main seat 122. The retainer 126 may extend beyond the top surface of the main seat 122 such that, when the spring 118 is seated on the main seat 122, the retainer 126 is in proximity with an outer perimeter of the spring 118 so as to engage the edge of the spring 118 and prevent the spring 118 from slipping off the main seat 122. This is helpful for ensuring a seal tight configuration. For example, when used in connection with the fuel tank system as depicted in FIG. 1, vapor pressure built up in the fuel tank may act upon the spring 118 and urge the spring 118 to be misaligned from the center axis 109. This in turn may offset the compliant seal 116 connected to the spring 118 to an undesirable position and/or orientation, potentially causing pressure or vacuum leakage and compromising fuel tank isolation. The retainer 126 according to this disclosure may eliminate such effect by perfectly aligning the spring 118 on the center axis 109 and in line with other components within the valve cavity 108, thereby ensuring a high level of seal tightness throughout the entire vapor control cycle. As an example and not by way of limitation, the retainer 126 and the main seat 122 may be molded as an unitary piece (e.g. via injection molding), or formed separately as needed (e.g., via insert molding, welding, etc.). Although depicted as a protrusion, the retainer 126 may take any other suitable forms such as a tab, a lock, a hook, or the like for retaining the spring 118 in place.

As such, the valve assembly housing in accordance with this disclosure can advantageously provide a wide and stable base for positioning and supporting components of the valve assembly and ensure proper alignment and retainment of valve components. Moreover, by means of the flow-friendly structures of the valve assembly housing, the fluid can travel through the valve system at a high flow rate, therefore improving fuel flow capability and vapor control performance. Further, due its simplified design, the valve assembly housing can be manufacture in an easier and cheaper way.

### RECITATION OF EMBODIMENTS

Embodiment 1: A valve assembly housing configured to house a valve assembly for a fuel tank, the valve assembly housing comprising: an inlet; an outlet positioned parallel to and lower than the inlet, the outlet and inlet having different axes; a valve cavity connected between the inlet and the outlet, the valve cavity being configured to house the valve assembly; and a main seat positioned in the valve cavity at a location proximate to where the valve cavity transitions to the outlet; wherein the main seat is configured to support a spring of the valve assembly disposed along a center axis of the valve cavity, and wherein the main seat comprises a retainer configured to retain the spring on the main seat.

Embodiment 2: The valve assembly housing of Embodiment 1, further comprising one or more side seats, which are configured to support the spring of the valve assembly together with the main seat.

Embodiment 3: The valve assembly housing of any one of Embodiments 1-2, wherein the main seat and the one or more side seats together form a supporting plane for supporting the spring thereon.

Embodiment 4: The valve assembly housing of any one of Embodiments 1-3, wherein the one or more side seats are positioned on a side wall of the valve cavity.

Embodiment 5: The valve assembly housing of any one of Embodiments 1-4, wherein fluid channels are formed between the main seat and the one or more side seats.

Embodiment 6: The valve assembly housing of any one of Embodiments 1-5, the fluid channels extend towards the outlet.

Embodiment 7: The valve assembly housing of any one of Embodiments 1-6, wherein the main seat is positioned at a bottom of the valve cavity.

Embodiment 8: The valve assembly housing of any one of Embodiments 1-7, wherein the retainer prevents the spring from deflecting away from the center axis.

Embodiment 9: The valve assembly housing of any one of Embodiments 1-8, wherein the retainer is configured proximately to an outer periphery of the spring.

Embodiment 10: The valve assembly housing of any one of Embodiments 1-9, wherein the retainer is a protrusion extending from the main seat.

Embodiment 11: The valve assembly housing of any one of Embodiments 1-10, wherein the main seat is formed integrally with the valve cavity.

Embodiment 12: The valve assembly housing of any one of Embodiments 1-11, wherein the main seat is formed by injection molding or insert molding.

Embodiment 13: The valve assembly housing of any one of Embodiments 1-12, wherein the retainer is formed by injection molding or insert molding.

Embodiment 14: The valve assembly housing of any one of Embodiments 1-13, wherein the main seat is configured with a shape of an airfoil.

Embodiment 15: The valve assembly housing of any one of Embodiments 1-14, wherein the main seat has a length that spans across a diameter of the spring.

Embodiment 16: A valve system comprising: a valve assembly having a spring; and a valve assembly housing comprising an inlet, an outlet positioned parallel to and lower than the inlet, the outlet and the inlet having different axes, a valve cavity connected between the inlet and the outlet, the valve cavity being configured to house the valve assembly, and a main seat positioned in the valve cavity at a location proximate to where the valve cavity transitions to the outlet; wherein the main seat is configured to support the spring of the valve assembly disposed along a center axis of the valve cavity, and wherein the main seat comprises a retainer configured to retain the spring on the main seat.

Embodiment 17: The valve system of Embodiment 16, wherein the valve assembly housing further comprises one or more side seats, which are configured to support the spring of the valve assembly together with the main seat.

Embodiment 18: The valve system of Embodiment 17, wherein the main seat and the one or more side seats together form a supporting plane for supporting the spring thereon.

Embodiment 19: A valve system comprising: a valve assembly having a spring; and a valve assembly housing comprising an outlet, a valve cavity connected to the outlet, the valve cavity being configured to house the valve assembly, and a main seat positioned in the valve cavity at a location proximate to where the valve cavity transitions to the outlet; wherein the main seat is configured to support the spring of the valve assembly disposed along a center axis of the valve cavity, and wherein the main seat comprises a retainer configured to retain the spring on the main seat.

Embodiment 20: The valve system of Embodiment 19, wherein the valve assembly housing further comprises one or more side seats, which are configured to support the spring of the valve assembly together with the main seat.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A valve assembly housing configured to house a valve assembly for a fuel tank, the valve assembly housing comprising:
an inlet;
an outlet positioned parallel to and lower than the inlet, the outlet and inlet having different axes;
a valve cavity connected between the inlet and the outlet, the valve cavity being configured to house the valve assembly; and
a main seat positioned in the valve cavity at a location proximate to where the valve cavity transitions to the outlet;
wherein the main seat is configured to support a spring of the valve assembly disposed along a center axis of the valve cavity, and wherein the main seat comprises a retainer configured to retain the spring on the main seat.

2. The valve assembly housing of claim 1, further comprising one or more side seats, which are configured to support the spring of the valve assembly together with the main seat.

3. The valve assembly housing of claim 2, wherein the main seat and the one or more side seats together form a supporting plane for supporting the spring thereon.

4. The valve assembly housing of claim 2, wherein the one or more side seats are positioned on a side wall of the valve cavity.

5. The valve assembly housing of claim 2, wherein fluid channels are formed between the main seat and the one or more side seats.

6. The valve assembly housing of claim 5, wherein the fluid channels extend towards the outlet.

7. The valve assembly housing of claim 1, wherein the main seat is positioned at a bottom of the valve cavity.

8. The valve assembly housing of claim 1, wherein the retainer prevents the spring from deflecting away from the center axis.

9. The valve assembly housing of claim 1, wherein the retainer is configured proximately to an outer periphery of the spring.

10. The valve assembly housing of claim 1, wherein the retainer is a protrusion extending from the main seat.

11. The valve assembly housing of claim 1, wherein the main seat is formed integrally with the valve cavity.

12. The valve assembly housing of claim 1, wherein the main seat is formed by injection molding or insert molding.

13. The valve assembly housing of claim 1, wherein the retainer is formed by injection molding or insert molding.

14. The valve assembly housing of claim 1, wherein the main seat is configured with a shape of an airfoil.

15. The valve assembly housing of claim 1, wherein the main seat has a length that spans across a diameter of the spring.

16. A valve system comprising:
a valve assembly having a spring; and
a valve assembly housing comprising:
an inlet;
an outlet positioned parallel to and lower than the inlet, the outlet and the inlet having different axes;
a valve cavity connected between the inlet and the outlet, the valve cavity being configured to house the valve assembly; and
a main seat positioned in the valve cavity at a location proximate to where the valve cavity transitions to the outlet;
wherein the main seat is configured to support the spring of the valve assembly disposed along a center axis of the valve cavity, and wherein the main seat comprises a retainer configured to retain the spring on the main seat.

17. The valve system of claim 16, wherein the valve assembly housing further comprises one or more side seats, which are configured to support the spring of the valve assembly together with the main seat.

18. The valve system of claim 17, wherein the main seat and the one or more side seats together form a supporting plane for supporting the spring thereon.

19. A valve system comprising:
a valve assembly having a spring; and
a valve assembly housing comprising:
an outlet;
a valve cavity connected to the outlet, the valve cavity being configured to house the valve assembly; and
a main seat positioned in the valve cavity at a location proximate to where the valve cavity transitions to the outlet;
wherein the main seat is configured to support the spring of the valve assembly disposed along a center axis of the valve cavity, and wherein the main seat comprises a retainer configured to retain the spring on the main seat.

20. The valve system of claim 19, wherein the valve assembly housing further comprises one or more side seats, which are configured to support the spring of the valve assembly together with the main seat.
